(19) United States
(12) Patent Application Publication
(10) Pub. No.: US 2010/0287498 A1
(43) Pub. Date: Nov. 11, 2010

(54) USER INTERFACE COMMAND DISAMBIGUATION IN A MULTI-WINDOW OPERATING ENVIRONMENT

(75) Inventors: Jonathan Palgon, Research Triangle Park, NC (US); Roberto Vila, Research Triangle Park, NC (US)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/436,930

(22) Filed: May 7, 2009

(51) Int. Cl. G06F 3/048

(52) U.S. Cl. 715/802

(57) ABSTRACT

A method of disambiguating a target window for a user input in a multi-window computing environment can include receiving a user input event in a multi-window computing environment rendered in a display by a processor of a computer. The method further can include determining whether a focus change had occurred from a previously focused application window to a currently focused application window within a threshold period of time. Finally a prompt can be rendered to disambiguate an intended target application window amongst the currently focused application window and the previously focused application window if a focus change had occurred within a threshold period of time and the user input event can be routed to a selected target application window amongst the currently focused application window and the previously focused application window. Otherwise the received user input event can be routed to the currently focused application window without first rendering the prompt.

### BACKGROUND OF THE INVENTION

1. Field of the Invention

The present invention relates to the field of multi-window operating environments and more particularly to user interface command management in multi-window operating environments.

2. Description of the Related Art

The user interface has formed part and parcel of the personal computing environment for many years. Essentially, the user interface provides the mechanism through which computer-human interactions occur. The legacy command line style user interface permits the end user to provide commands and parameters to underlying application logic in sequence. The modern graphical user interface provides a more versatile operating environment in which end users can interact with multiple different applications concurrently, each with a separate visual view either side-by-side, or overlapping one another.

Generally, the conventional graphical user interface provides a desktop work area in which multiple application windows can be rendered of different dimensions. User input can be permitted by way of keyboard, mouse or even audio means. Of course, in that multiple application windows can reside within the desktop coextensively, the operating environment must maintain an awareness of which application window is active and hence, enjoys “focus”. User input ordinarily can be directed to the event loop of the application window enjoying focus rather than other inactive application windows present in the desktop.

End users select different application windows in a graphical user interface through different means such as directing a mouse click to a portion of an application window adjacent or below a mouse pointer, or through a keyboard shortcut such as “ALT-TAB” or the closing of an active window by way of the operation of a mouse pointer, menu command such as “File|Exit” or keyboard short cut such as “ALT-F4”. Alternatively, application window focus can change programmatically at the behest of an executing application or at the behest of the operating system itself. As yet a third alternative, a new application window can launch and gain focus programmatically, such as in the case of a programmatically generated message box or dialog box. Oftentimes, the spontaneous rendering and activation of an application window or the spontaneous activation of an existing window is neither inconvenient nor unexpected for the end user.

Even still, other times, the spontaneous rendering and activation of an application window or the spontaneous activation of an existing window can be unexpected, ill timed and, as a result, problematic for the end user. Specifically, on occasion as the end user directs user input intended for an active application window, focus amongst application windows on the desktop can change programmatically without prior notice to the end user. In that event, the user input can be routed to the event loop of a different application window resulting in unintended consequences such as the unintentional closing of the different application window. In the worst case, data can be lost resulting in much more than a minor annoyance to the end user.

### BRIEF SUMMARY OF THE INVENTION

Embodiments of the present invention address deficiencies of the art in respect to user input event processing in a graphical user interface and provide a novel and non-obvious method, system and computer program product for disambiguating a target window for a user input in a multi-window computing environment. In an embodiment of the invention, a method of disambiguating a target window for a user input in a multi-window computing environment can include receiving a user input event in a multi-window computing environment rendered in a display by a processor of a computer. The method further can include determining whether a focus change had occurred from a previously focused application window to a currently focused application window within a threshold period of time.

Finally a prompt can be rendered to disambiguate an intended target application window amongst the currently focused application window and the previously focused application window if a focus change had occurred from a previously focused application window to a currently focused application window within a threshold period of time and the user input event can be routed to a selected target application window amongst the currently focused application window and the previously focused application window. Otherwise the received user input event can be routed to the currently focused application window without first rendering the prompt. Optionally, the prompt can be rendered only if the user input event also can be located within a table of protected events.

In another embodiment of the invention, a data processing system can provide a multi-window computing environment. The system can be configured for disambiguating a target window for a user input in a multi-window computing environment and can include a computer with processor and memory, an operating system executing in the memory of the computer by the processor of the computer, and a graphical user interface provided by the operating system to include different application windows for different applications hosted by the operating system. Finally, a user input disambiguation module can be coupled to the graphical user interface.

The module can include program code enabled upon execution to determine whether a focus change had occurred from a previously focused one of the application windows to a currently focused one of the application windows within a threshold period of time preceding a receipt of a user input event in the graphical user interface, and to render a prompt to disambiguate an intended one of the target application windows amongst the currently focused one of the application windows and the previously focused one of the application windows if a focus change had occurred from a previously focused application window to a currently focused application window within a threshold period of time, but to otherwise route the received user input event to the currently focused application window without first rendering the prompt. Optionally, a table of protected events can be coupled to the user input disambiguation module, such that the program code of the module can be further enabled to render the prompt only if the user input event can be located within the table of protected events.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for disambiguating a target window for a user input in a multi-window computing environment;

FIG. 2 is a schematic illustration of a data processing system providing a multi-window computing environment and configured for disambiguating a target window for a user input in a multi-window computing environment; and,

FIG. 3 is a flow chart illustrating a process for disambiguating a target window for a user input in a multi-window computing environment.

### DETAILED DESCRIPTION OF THE INVENTION

Embodiments of the present invention provide a method, system and computer program product for disambiguating a target window for a user input in a multi-window computing environment. In accordance with an embodiment of the present invention, user input events can be trapped for analysis as the user input events are received in a graphical user interface for a desktop operating environment. During the analysis of a trapped user input event, it can be determined whether or not a change in focus between a previously focused window and a currently focused window had occurred within a threshold period of time. If so, a target application window for the trapped user input event can be disambiguated between the previously focused window and a currently focused window.

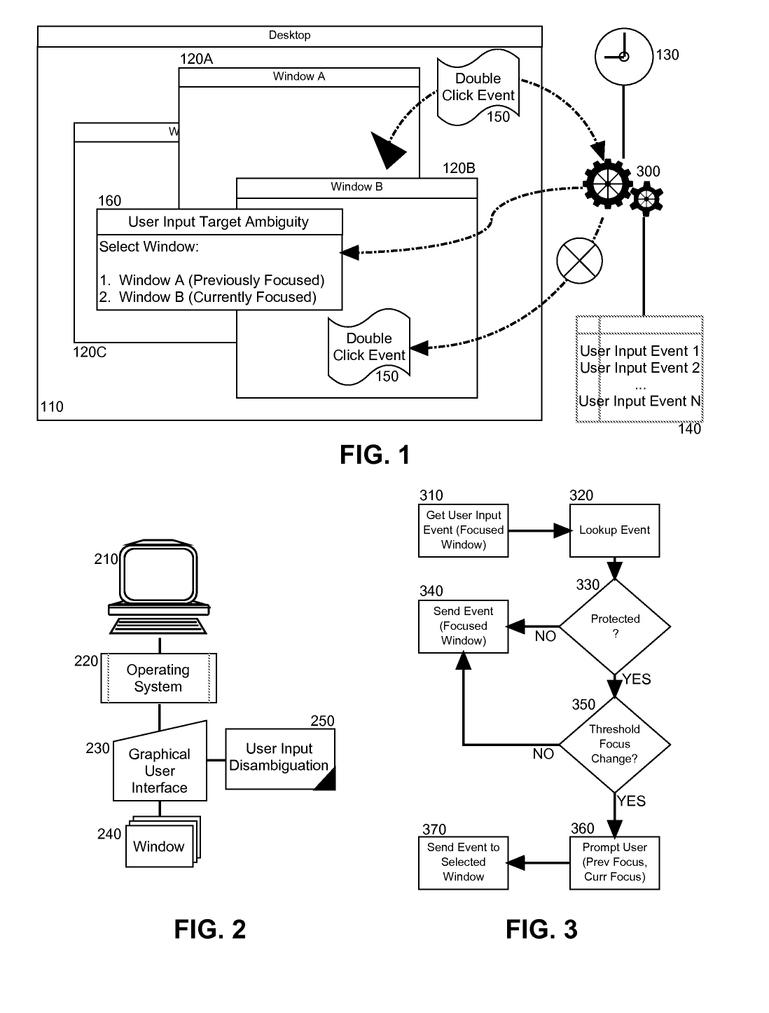

In further illustration, FIG. 1 is a pictorial illustration of a process for disambiguating a target window for a user input in a multi-window computing environment. As shown in FIG. 1, a desktop computing environment 110 providing a graphical user interface for an operating system can be provided to host multiple different application windows 120A, 120B, 120C. A user input event 150 such as a mouse click or keyboard stroke can be captured in the desktop computing environment 110 in association with a focused one of the application windows 120A, 120B, 120C. A user disambiguation process 300 can determine by reference to a threshold timer 130 whether or not a most recently focused one of the application windows 120A, 120B, 120C had become focused from a previously focused one of the application windows 120A, 120B, 120C within a threshold period of time. If so, a user input disambiguation dialog 160 can be provided as a prompt for the end user to expressly select a target one of the application windows 120A, 120B, 120C to receive the user input event 150. Optionally, the user input disambiguation dialog 160 can be provided only in response to the receipt of a user input event 150 mapping to an entry in a table of protected user input events 140 for disambiguation, such as “File|Close”, “ALT F4” or “File|Exit” events intended to result in the closing of an application window or an application associated with an application window, respectively.

The process described in connection with FIG. 1 can be implemented within a data processing system providing a multi-window computing environment such as that shown in FIG. 1. In yet further illustration, FIG. 2 schematically depicts a data processing system providing a multi-window computing environment and configured for disambiguating a target window for a user input in a multi-window computing environment. As shown in FIG. 2, a host computing platform 210 with processor and memory can support the execution of an operating system 220. The operating system 220 in turn can provide a graphical user interface 230 such as a desktop computing environment and can host the operation of one or more applications each directing the rendering of one or more application windows 240 in the graphical user interface 230.

Of import, user input disambiguation module 250 can be coupled to the graphical user interface 230. The user input disambiguation module 250 can include a set of computer readable instructions defining computer usable program code enabled to disambiguate user input with respect to the application windows 240 rendered in the graphical user interface 230. Specifically, the program code can be enabled to detect user input in the graphical user interface 230 directed to one of the application windows 240. To the extent that a focus change had occurred between a last focused one of the application windows 240 and a newly focused one of the application windows 240 within a threshold period of time, a prompt can be rendered in the graphical user interface 230 requesting a specific directive as to which of the last focused and newly focused one of the application windows 240 the event is to be routed. Optionally, the operation of the program code can be limited to a select set of events pre-configured in association with the user input disambiguation module 250.

In even yet further illustration of the operation of the user input disambiguation module 250, FIG. 3 is a flow chart illustrating a process for disambiguating a target window for a user input in a multi-window computing environment. Beginning in block 310, a user input event can be received resulting from user input such as a keyboard stroke or combination of keyboard strokes, or a mouse click or mouse clicks, or a combination of a keyboard stroke or strokes and a mouse click or mouse clicks. In block 320, the event can be compared to a table of protected events and in decision block 330, it can be determined whether or not the event is listed in the table of protected events. If not, in block 340 the event can be passed to the currently focused application window. Otherwise, the process can continue through decision block 350.

In decision block 350, it can be determined whether a focus change had occurred within a threshold period of time from a previously focused application window to the currently focused application window. If not, in block 340 the event can be passed to the currently focused application window. Otherwise, in block 360 a prompt can be rendered listing both the currently focused application window and the previously focused application window inviting the user to choose between the two. Thereafter, in block 370 the event can be routed to a selected application window amongst the currently focused application window and the previously focused application window. In this way, the intended application window can be determined without assuming that the event is to be routed to the currently focused application window despite the recent change of focus from the previously focused application window to the currently focused application window.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method of disambiguating a target window for a user input in a multi-window computing environment, the method comprising:
receiving a user input event in a multi-window computing environment rendered in a display by a processor of a computer;
determining whether a focus change had occurred from a previously focused application window to a currently focused application window within a threshold period of time; and,
rendering a prompt to disambiguate an intended target application window amongst the currently focused application window and the previously focused application window if a focus change had occurred from a previously focused application window to a currently focused application window within a threshold period of time and routing the user input event to a selected target application window amongst the currently focused application window and the previously focused application window, but otherwise routing the received user input event to the currently focused application window without first rendering the prompt.

2. The method of claim 1, wherein rendering a prompt to disambiguate an intended target application amongst the currently focused application window and the previously focused application window, comprises:
determining whether the user input event can be located within a table of protected events; and,
rendering a prompt to disambiguate an intended target application amongst the currently focused application window and the previously focused application window if the user input event can be located within the table of protected events and if a focus change had occurred from a previously focused application window to a currently focused application window within a threshold period of time, routing the user input event to a selected target application window amongst the currently focused application window and the previously focused application window, but otherwise routing the received user input event to the currently focused application window without first rendering the prompt.

3. The method of claim 1, wherein the user input event is a window close event for an application window.

4. The method of claim 1, wherein the user input event is an application exit event for an application associated with an application window.

5. A data processing system providing a multi-window computing environment and configured for disambiguating a target window for a user input in a multi-window computing environment, the system comprising:
a computer with processor and memory;
an operating system executing in the memory of the computer by the processor of the computer;
a graphical user interface provided by the operating system and comprising a plurality of different application windows for different applications hosted by the operating system; and,
a user input disambiguation module coupled to the graphical user interface, the module comprising program code enabled upon execution to determine whether a focus change had occurred from a previously focused one of the application windows to a currently focused one of the application windows within a threshold period of time preceding a receipt of a user input event in the graphical user interface, and to render a prompt to disambiguate an intended one of the target application windows amongst the currently focused one of the application windows and the previously focused one of the application windows if a focus change had occurred from a previously focused application window to a currently focused application window within a threshold period of time, but to otherwise route the received user input event to the currently focused application window without first rendering the prompt.

6. The system of claim 5, further comprising a table of protected events coupled to the user input disambiguation module, the program code of the module being further enabled to render the prompt only if the user input event can be located within the table of protected events.

7. The system of claim 5, wherein the user input event is a window close event for an application window.

8. The system of claim 5, wherein the user input event is an application close event for an application associated with an application window.

9. A computer program product comprising a computer usable medium embodying computer usable program code for disambiguating a target window for a user input in a multi-window computing environment, the computer program product comprising:
computer usable program code for receiving a user input event in a multi-window computing environment rendered in a display by a processor of a computer;
computer usable program code for determining whether a focus change had occurred from a previously focused application window to a currently focused application window within a threshold period of time; and,
computer usable program code for rendering a prompt to disambiguate an intended target application window amongst the currently focused application window and the previously focused application window if a focus change had occurred from a previously focused application window to a currently focused application window within a threshold period of time and routing the user input event to a selected target application window amongst the currently focused application window and the previously focused application window, but otherwise routing the received user input event to the currently focused application window without first rendering the prompt.

10. The computer program product of claim 9, wherein the computer usable program code for rendering a prompt to disambiguate an intended target application amongst the currently focused application window and the previously focused application window, comprises:
computer usable program code for determining whether the user input event can be located within a table of protected events; and,
computer usable program code for rendering a prompt to disambiguate an intended target application amongst the currently focused application window and the previously focused application window if the user input event can be located within the table of protected events and if a focus change had occurred from a previously focused application window to a currently focused application window within a threshold period of time, routing the user input event to a selected target application window amongst the currently focused application window and the previously focused application window, but otherwise routing the received user input event to the currently focused application window without first rendering the prompt.

11. The computer program product of claim 9, wherein the user input event is a window close event for an application window.

12. The computer program product of claim 9, wherein the user input event is an application exit event for an application associated with an application window.
